(19) United States
(12) Patent Application Publication
(10) Pub. No.: US 2026/0356496 A1
(43) Pub. Date: Nov. 12, 2026

(54) POSITION BASED PYLON CONVERSION ACTUATOR LATENT FAILURE TESTING

(71) Applicant: Textron Innovations Inc., Providence, RI (US)

(72) Inventors: Jacob Augustyn, Grapevine, TX (US); Charles Eric Covington, Colleyville, TX (US); Ryan Lotz, Flower Mound, TX (US); Carlos Fenny, Fort Worth, TX (US)

(21) Appl. No.: 19/203,071

(22) Filed: May 8, 2025

(51) Int. Cl. B64F 5/60; B64C 27/52; B64D 27/40; B64D 45/00

(52) U.S. Cl. CPC B64F 5/60; B64C 27/52; B64D 27/402; B64D 45/00; B64D 2045/0085

(57) ABSTRACT

A system and method for testing aircraft pylon version actuator latent failures, the method including driving a pylon conversion actuator (PCA) to a predetermined position, driving a selected element of the PCA to attempt to move a PCA element as part of a position based test for failure of a test element of the PCA, acquiring an operating parameter measurement by a resolver connected to the PCA element, the operating parameter measurement being associated with an operating parameter of the PCA element, wherein the operating parameter is associated with movement while the selected element of the PCA is being driven or position of the PCA element as a result of the PCA being driven, determining, according to a relationship between the operating parameter and a threshold, whether the test element fails the position based test, and raising an alert in response to the test element failing the test.

### TECHNICAL FIELD

The present invention relates generally to a system and method for testing hydraulic drive motor system, and, in particular embodiments, to a system and method for providing testing primary motor torque, backup motor torque, brake holding force, and gearbox resolvers without using delta pressure sensing for a hydraulically driven actuator.

### BACKGROUND

Generally, the complexity of aircraft parts, combined with the critical nature of many elements of the aircraft, result in the durability and safety of many parts requiring significant maintenance, inspection and testing. Critical parts needed to safely operate the aircraft are of particular concern, and the potential for latent failures is an area in which testing may assist maintenance personnel to improve aircraft maintenance procedures. A latent failure may be a condition that exists in an aircraft, aircraft element, mechanisms or subsystems, or the like. The latent failures may be defects that exists in a part, but that are not immediately apparent, as the part may work nominally, even with the defect. A latency period in the context of latent failures refers to a time span between when a failure occurs within a system and when it becomes noticeable or manifests as a problem. This is essentially the period where the failure is dormant and not causing immediate issues, often only triggered by specific events or conditions.

Moving parts, such as transmissions, control surface actuators, propulsion systems, landing gear, and the like, are particularly susceptible to failures since those parts tend to experience the most stress and fatigue during normal use. Additionally, these aircraft elements tend to be some of the most critical elements, and testing for potential failures should performed regularly. For tilt-wing aircraft, the mechanisms handling tilting of the rotors are some the most critical aircraft elements, and testing of the tilt mechanism elements is regularly performed to attempt to detect any latent defects.

### SUMMARY

An embodiment method comprises driving a pylon conversion actuator (PCA) that controls tilt of a pylon of a tilt-wing aircraft to a predetermined position, driving a selected element of the PCA to attempt to move a PCA element of the PCA, wherein driving the selected element of the PCA is part of a position based test for failure of a test element of the PCA, acquiring an operating parameter measurement by a resolver mechanically connected to the PCA element, wherein the operating parameter measurement is associated with an operating parameter of the PCA element, wherein the operating parameter is associated with movement while the selected element of the PCA is being driven or position of the PCA element as a result of the PCA being driven, determining, according to a relationship between the operating parameter and a threshold, whether the test element fails the position based test, and raising an alert through an alert system in response to the test element failing the test.

An embodiment system includes one or more processors, and at least one non-transitory computer readable memory connected to the one or more processors and including computer program code implementing a position based test for failure of a test element of pylon conversion actuator (PCA) that controls tilt of a pylon of a tilt-wing aircraft. The at least one non-transitory computer readable memory and the computer program code are configured, with the one or more processors, to cause the system to perform at least driving a selected element of the PCA to attempt to move a PCA element, acquiring operating parameter measurement by a resolver mechanically connected to the PCA element, wherein the operating parameter measurement is associated with an operating parameter of the PCA element, wherein the operating parameter is associated with movement while the selected element of the PCA is being driven or position of the PCA element as a result of the PCA being driven, determining, according to a relationship between the operating parameter and a threshold, whether the test element fails the position based test, and raising an alert through an alert system in response to the test element failing the test.

An embodiment method includes driving a selected element of a pylon conversion actuator (PCA) of a tilt-wing aircraft to attempt to move a PCA element of the PCA, wherein driving the selected element of the PCA is part of a position based test for failure of a test element of the PCA, enabling a selected holding element, wherein the selected holding element attempts to restrain drive of the selected element, acquiring an operating parameter measurement wherein the operating parameter measurement is associated with an operating parameter of the PCA element, wherein the operating parameter is associated with movement of a ballscrew of the PCA while the selected element of the PCA is being driven or position of the PCA element as a result of the PCA being driven, determining, according to the operating parameter, whether the test element fails the position based test, and raising an alert through an alert system in response to the test element failing the test.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram illustrating a tilt-wing rotorcraft according to some embodiments;

FIG. 2 is a diagram illustrating a pylon conversion actuator (PCA) according to some embodiments;

FIG. 3 is a diagram illustrating a PCA with resolvers according to some embodiments;

FIG. 4A is a logical diagram illustrating a PCA system with resolvers according to some embodiments;

FIG. 4B is a logical diagram illustrating a PCA testing system according to some embodiments;

FIG. 5A is a diagram illustrating a PCA under test according to some embodiments;

FIG. 5B is a flow diagram illustrating a method for testing elements of a PCA according to some embodiments;

FIG. 6 is a flow diagram illustrating a method for performing a primary HPDU torque comparison test according to some embodiments;

FIG. 7 is a flow diagram illustrating a method for performing a primary brake system hold torque test according to some embodiments;

FIG. 8 is a flow diagram illustrating a method for performing a backup HPDU torque comparison test according to some embodiments;

FIG. 9 is a flow diagram illustrating a method for performing a backup brake system hold torque test according to some embodiments;

FIG. 10 is a flow diagram illustrating a method for performing an independent primary HPDU torque confirmation test according to some embodiments; and

FIG. 11 is a flow diagram illustrating a method for performing a gearbox resolver verification test according to some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

Aircraft systems and components which have latent failure modes must have periodic checks to bound the period of latency. This is frequently done by pre-flight built-in testing (PFBIT). In particular, pylon conversion actuator (PCA) hydraulic motors and brakes for tilt-rotor aircraft have such failure modes. While differential pressure measurements using integrated sensors may be used for PFBIT testing, systems without the integrated pressure sensors are unable to perform the differential pressure testing.

Accurate testing of the PCA hydraulic motors and brakes for tilt-ting aircraft may be accurately tested using resolvers as sensors for position based testing. This avoids the requirements for hydraulic pressure sensors for PFBIT testing, and permits use of existing resolver systems or other sensors for PFBIT testing without requiring differential pressure testing. Additionally, the position based testing may permit a dual stall that is required to fully test for latent failures in a brake, rather than testing latent failures of the PCA brakes with a single motor stall into the brakes, which may not fully test the brakes. Furthermore, the position based testing permits testing for latent failures in gearbox resolvers since the movement of the gearbox can be detected by the resolvers, and known movement of the gearbox that is not accurately reported by the gearbox resolvers can be detected as a resolver failure.

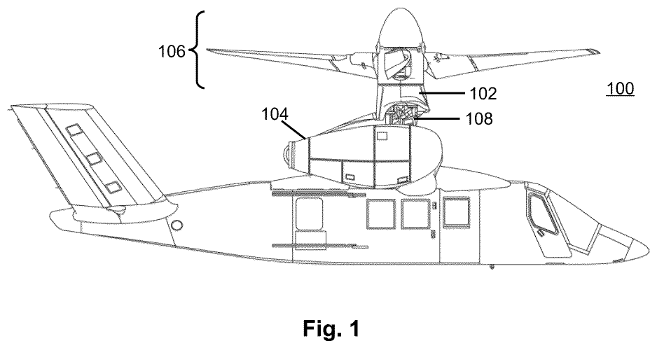

FIG. 1 is a diagram illustrating a tilt-wing rotorcraft 100 according to some embodiments. A tilt-rotor aircraft 100 has rotor systems 106 that tilt to provide vertical or horizontal thrust. This permits the tilt-rotor aircraft 100 to take off and land vertically when the rotor system 106 is tilted upward, or to fly like a conventional aircraft when the rotor systems 106 are tilted forward. In recent tilt-rotor aircraft 100, the rotor systems 106 are supported by a front pylon section 102 that pivots on a tilting mechanism 108. The tilting mechanism 108 permits the main portion of the pylon 104 to remain stationary, with just the front pylon section 102 and rotor system 106 rotating. The engines reside in the main portion of the pylons 104, and keeping the main portion of the pylons 104 stationary reduces the strain and complexity of the tilting mechanism 108.

A pylon conversion actuator (PCA) (not shown here) controls the tilt of the front pylon section 102. Each pylon 104 may have a separate PCA, with each PCA having separate drive systems, sensors, and the like.

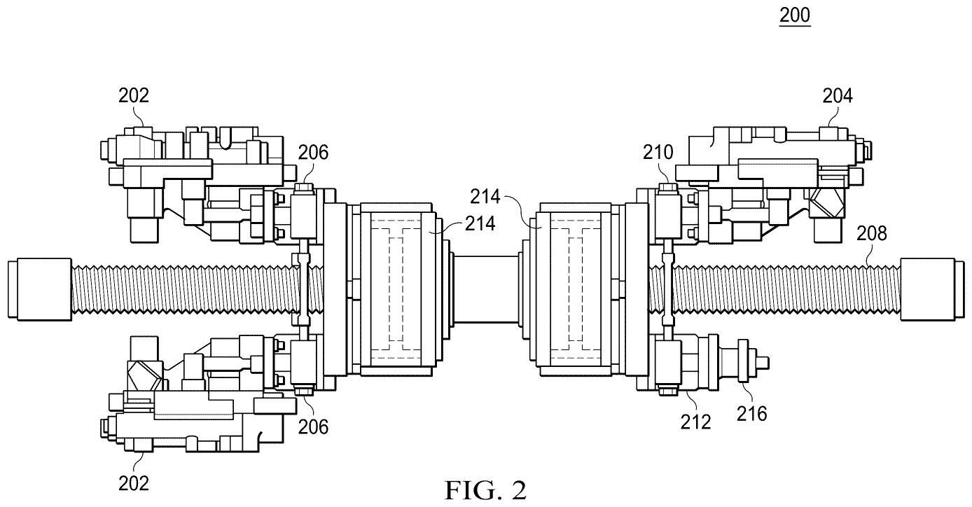

FIG. 2 is a diagram illustrating a PCA 200 for according to some embodiments. A PCA 200 may have a ballscrew 208 system that is driven by one or more hydraulic power drive units (HPDUs), and may, in some embodiments, have one or more primary HPDUs (PHPDUs) 202 and one or more backup HPDUs (BHPDUs) 204. In some embodiments, the PHPDUs 202 or BHPDUs 204 may each have a delta pressure sensor.

The HPDUs 202, 204 may drive a ballscrew 208 through a gear system, drive train, transmission, or the like. In some embodiments, the ballscrew 208 has multiples sections, with the PHPDUs 202 driving one section of the ballscrew 208 and the BHPDU driving a second portion of the ballscrew 208. The different section of the ballscrew 208 may connect to one or more trunnion housings 214, which are, in turn, affixed to a support portion of the aircraft, so that the retraction or extension of the ballscrew 208 by either the PHPDUs 202 or BHPDU 204 causes the rotors of a tilt-wing to tilt up or down.

Each PHPDU 202 may have a primary brake 206 that holds, or stops movement of, a gear or other drive system element to prevent the relevant portion of the ballscrew 208 from turning. Similarly, the BHPDU 204 may have a backup brake 210. A second backup brake, such as a redundant backup brake 212 may be separately connected to the ballscrew 208 through a gear system, drive train, transmission, or the like. The PCA 200 may further have a manual drive assembly 216 connected to a gear drive so that the ballscrew 208 may be manually activated.

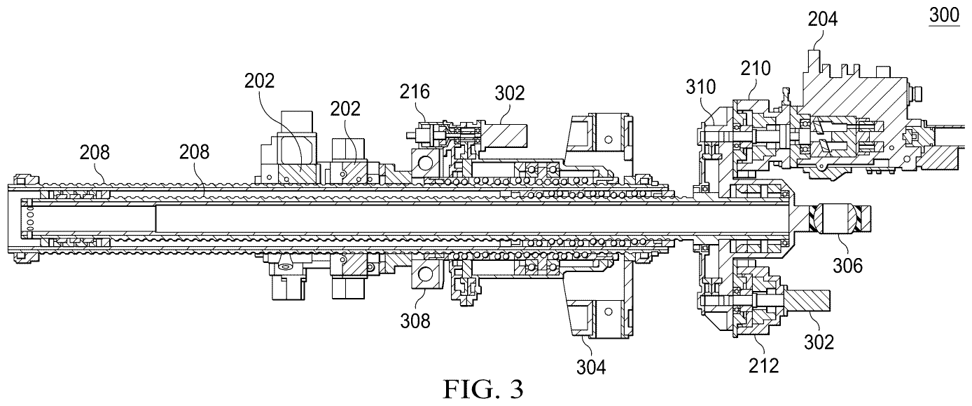

FIG. 3 is a diagram illustrating a PCA 300 with resolvers 302 according to some embodiments. The PCA 300 may have a first gear drive 308 connected to a gimbal wing attachment 304 and to a first portion of the ballscrew 208. The PHPDUs 202 may be mechanically connected to the ballscrew 208 through the first gear drive 308, with the PHPDUs 202 configured to drive the ballscrew 208 in reference to the gimbal wing attachment 304, which acts as a mechanical reference for the ballscrew 208. The PCA 300 may further have one or more primary brakes (not shown here) associated with the PHPDUs 202, and that may hold the outputs or gears of the PHPDUs 202 to attempt to hold the first gear drive 308 stationary or restrain the first gear drive 308 from moving, for example, as a result of being driven by one of the PHPDUs 202.

In some embodiments, the PCA 300 may further have a manual drive assembly 216 mechanically connected to the first gear drive 308, and which permits manual actuation of the first gear drive 308. In other embodiments, the manual drive assembly 216 is disposed on the second gear drive 310, or on another arrangement. The manual drive assembly 216 may, for example, be accessed by maintenance personnel or the like to change the tilt of the front pylon section or rotor assembly when power is not available, when the PCA 300 itself is inoperable due to hydraulic failure, control system failure, mechanical damage, or the like.

A second portion of the ballscrew 208 may, in some embodiments, interact with the first portion of the ballscrew 208 so that the second portion of the ballscrew 208 can be retracted or extended in relation to the first portion of the ballscrew 208 by the BHPDU 204. The BHPDU 204 may be connected to the ballscrew 208 by a second gear drive 310 and to a pylon attachment 306. The BHPDU 204 drives the ballscrew 208, and in some embodiments, drives the second portion of the ballscrew 208 to retract or extend the call screw with the pylon attachment 306 as a reference point. The PCA may also have one or more backup brakes 210 associated with the BHPDU 204, and a redundant backup brake 212, with the backup brake 210 and redundant backup brake 212 mechanically connected to the second gear drive 310 to restrain the second gear drive 310 from moving when the backup brake 210 or redundant backup brake 212 is engaged.

In some embodiments, the PCA 300 has one or more resolvers 302. A resolver is a type of rotary electrical transformer used for measuring degrees of rotation. As a rotor of the resolver 302 is turned, the resolver 302 generates an electrical signal that indicates a relative angle of the resolver 302 rotor to the resolver 302 body or stator. Each resolver 302 may be separately attached to the PCA 300 so that each resolver 302 can acts as a redundant measuring device for each other resolver 302. In some embodiments, the PCA 300 may have three or more resolvers 302 connected to the first gear drive 308, and each PHPDU 202 may have an associated resolver 302. The resolvers 302 may be connected to the first gear drive 308 so that the resolvers detect or measure movement of the first gear drive 308, as movement in the first gear drive 308 rotating the resolvers 302, and causes the resolvers 302 to generate signals indicating a change in angle, or indicating different angles over time. The PCA 300 may have one or more resolvers 302 connected to the second gear drive 310 and may be connected to the second gear drive 310 to measure or detect movement if the second gear drive 310. The resolvers 302 connected to the second gear drive 310 may be associated with the BHPDU 204 and the redundant backup brake 212 to monitor movement of the second gear drive 310 based on control of the second gear drive 310 the associated BHPDU 204 or redundant backup brake 212.

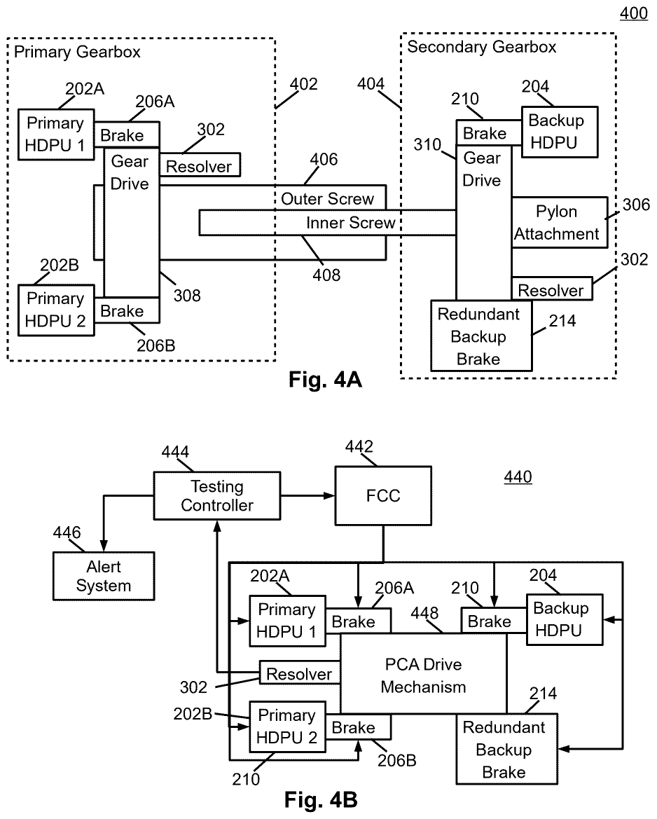

FIG. 4A is a logical diagram illustrating a PCA system 400 with resolvers according to some embodiments. In some embodiments, the PCA system 400 has a primary gearbox 402 and a secondary gearbox 404. The primary gearbox 402 has a first PHPDU 202A and associated first primary brake 206A, and a second PHPDU 202B and associated second primary brake 206B. The first PHPDU 202A and second PHPDU 202B are arranged to independently drive the first gear drive 308, and in turn, to drive the outer screw 406 to extend or retract the outer screw 406. The first primary brake 206A and second primary brake 206B are arranged to independently engage with the first gear drive 308 and hold the first gear drive 308 to restrain the first gear drive 308 from moving the outer screw 406 when engaged.

In some embodiments, the secondary gearbox 404 has a BHPDU 204, and an associated backup brake 210. The BHPDU 204 is arranged to drive the second gear drive 310, and in turn to drive the inner screw 408 to extend or retract. In some embodiments, the secondary gearbox 404 further has a redundant backup brake 212, and in some embodiments, the redundant backup brake is remote or separate from the backup brake 210 and the BHPDU. Thus, while the secondary gearbox 404 has a single HPDU, the secondary gearbox 404 has multiple brakes, each of which has holding power sufficient to hold, stop or otherwise restrain the BHPDU 204, and should be powerful enough to brake or hold both PHPDUs 202A, 202B.

In some embodiments, the ballscrew has an outer screw 406 and an inner screw 408, with the primary gearbox 402 connected to the outer screw 406, and the secondary gearbox 404 connected to the inner screw 408. The inner screw 408 may interact with the outer screw 406 by screwing into the outer screw 406 when driven by the BHPDU 204. Thus, the outer screw 406 may be driven by the primary HPDUs 202A, 202B, in turn driving the inner screw 408.

The primary gearbox 402 may have one or more resolvers 302 that are connected to the first gear drive 308, and are configured to detect movement or drive the first gear drive 308 or within the first gearbox 402. The secondary gearbox 404 also has one or more resolvers 302 that are connected to the second gear drive 310, and that are configured to detect movement or drive of the second gear drive 310 or within the secondary gearbox 404. In some embodiments, the resolvers 302 may be used as servoloop feedback mechanisms, and may provide data regarding movement or position of the ballscrew, the PCA, the gearboxes 402, 404, the gear drives 308, 310, or the like. In some embodiments, the HPDU may be instructed to hold the ballscrew at a particular position, or to hold the pylon or front pylon portion at a particular position, and may implement servoloop positioning using position information from one or more resolvers 302 to adjust the position of the relevant element by determining an offset or error of the actual potion from the desired position, and may adjust the drive of the HPDU based on the offset associated with the resolver data.

The resolvers 302 may be used to enable testing of primary motor or PHPDU torque, backup motor or BHPDU torque, brake holding force, and verification of the resolvers. In particular, testing may include primary motor torque comparison, testing primary brake holding force, backup motor torque comparison, testing backup braking holding force, performing independent motor torque confirmation, and performing gearbox resolver verification. Use of the resolvers permits these various testing processes to be performed without using delta pressure sensing for a conversion actuator, and permits omission of pressure sensors in the HPDUs completely.

FIG. 4B is a logical diagram illustrating a PCA testing system 440 according to some embodiments. For testing, PCA elements, such as the PHPDUs, 202A, 202B, BHPDU 204, and brakes 206A, 206B, 210, 212 may be controlled by a flight control computer (FCC) 442. The FCC 442 may provide control instructions to the PCA elements in response to test commands from a testing controller 444, which may receive data from resolvers 302 connected to one or more elements of a PCA drive mechanisms, such as gear drives, ballscrew, or the like. The testing controller 444 may determine whether different elements pass or fail the relevant tests and may raise an alert, or caused an alert system to raise an alert. Thus, if a the PCA fails a particular test, which may indicate a latent failure in a PCA element, or that a failure has occurred, that a particular element of the PCA or the PCA itself needs maintenance or inspection, or the like. In some embodiments, the alert system 446 may provide an audio, visual or other alert to, for example, a pilot running a PFBIT test, maintenance personal running maintenance tests, or the like. In other embodiments, the alert system 446 may provide a database entry, note, maintenance appointment, or the like, to a maintenance scheduling system, maintenance log, or another maintenance management system.

The FCC 442, testing controller 444, alert system 446, or individual elements or subsystems thereof may be implemented on one or more computer systems, for example, using standalone computers, one or more servers, and/or cloud computing resources or systems. Thus, the PCA testing system 440 or a subsystem may have one or more processors and one or more non-transitory computer readable memory or media, which may store computer program code for implementing functionality of the system.

References to computer-readable storage medium, computer program product, tangibly embodied computer program, or the like, or a controller, display system, computer, processor, or the like should be understood to encompass not only computers having different architectures such as single or multi-processor architectures and sequential (Von Neumann) or parallel architectures but also specialized circuits such as field-programmable gate arrays (FPGAs), application specific circuits (ASICs), signal processing devices and other devices. References to computer program, instructions, code, or the like, should be understood to encompass software for a programmable processor or firmware such as, for example, the programmable content of a hardware device whether instructions for a processor, or configuration settings for a fixed-function device, gate array or programmable logic device, or the like.

The PCA testing system 440 may have at least one processor and at least one memory, such as a non-transitory computer readable medium, and may include computer program code, that is configured to, with the at least one processor, provide the position based testing features. The memory may be a single component or, may be implemented as one or more separate components, some or all of which may be integrated or removable and may provide permanent, semi-permanent, dynamic, or cached storage.

The one or more processors are configured to read from and write to the at least one memory. The processor may also comprise an output interface via which data or commands are output by the processor and an input interface via which data or commands are input to the processor. The memory stores a computer program including computer program instructions that control the operation, when loaded into the processor, of the overall PCA testing system 440, or one or more of FCC 442, testing controller 444, or alert system 446. The computer program instructions provide the logic and routines that enable the system to perform the position based testing, PCA element control, alert management, or the like. The processor, by reading the memory, is able to load and execute the computer program. The computer program or programs may arrive at the apparatus via any suitable delivery mechanism. The delivery mechanism may be, for example, a computer-readable storage medium, a computer program product, a memory device, a record medium such as a compact disc read only memory (CD-ROM), digital versatile disc (DVD), portable memory such as a memory stick or hard drive, or the like, an article of manufacture that tangibly embodies the computer program. In some embodiments, the delivery mechanism may be a signal configured to reliably transfer the computer program over the air or via an electrical or optical connection.

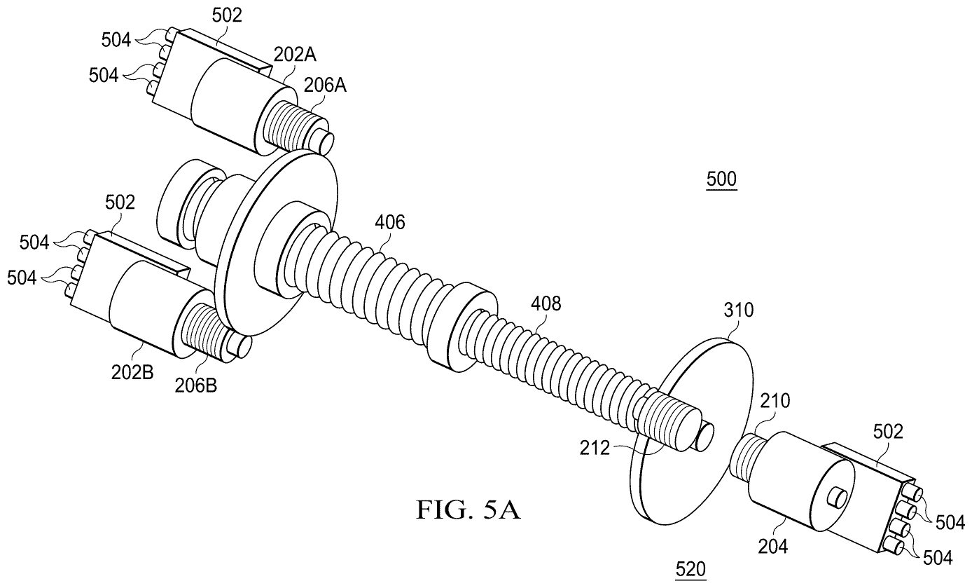

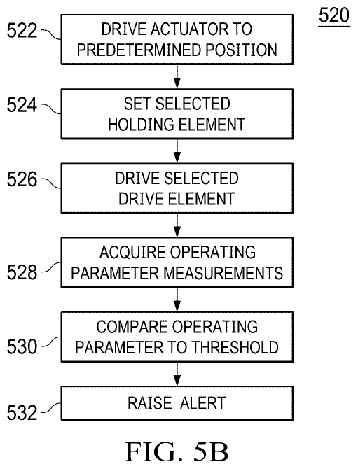

FIG. 5A is a diagram illustrating a PCA under test 500 according to some embodiments. Each HPDU 202A, 202B, 204 has a solenoid block 502 with one or more valves that control the flow of hydraulic fluid to drive or engage different hydraulic features, or to disengage or engage the brake 206A, 206B, 210, 212 features.

For example, the PCA may receive operating commands from, for example, an FCC according to a test being run by a test controller. The operating commands may be one or more commands to open a hydraulic valve 504 at a solenoid block 502 for the first PHPDU 202A, causing the first PHPDU 202A to turn in a particular direction, and to release the first primary brake 206A so that the first PHPDU 202A drives the first gear drive 308 and extend or retract the outer screw 406.

FIG. 5B is a flow diagram illustrating a method 520 for testing elements of a PCA according to some embodiments. In block 522, the PCA may be moved to a particular position. For example, in some embodiments, the PCA may be extended to cause the pylon front portion to rest vertically, or to be at 90 degrees to reduce pressure or stress on the pivot mechanism. In other embodiments, the PCA may be extended or retracted so that the inner or outer screws are fully extended or retracted and mechanically bottomed out or grounded.

In block 524, one or more selected holding elements are set. In some embodiments, setting the selected holding element may include setting or releasing one or more brakes, setting a HPDU to hold a particular position, setting the PCA or ballscrew to a mechanically grounded position, such as a bottomed out or end position such as at a fully extended, or fully retracted position., or the like. In block 526, a selected drive element is driven. In some embodiments, a selected drive element may be driven according to operating commands, instructions, test protocols, or the like. The hold and drive of the selected holding element and drive elements may be implemented by activating relevant valve that releases, engages, or drives the selected element, and the operating commands may be signals that turn off, turn on, disengage, engage, or otherwise manipulate or control, for example, a solenoid that opens or closes a selected hydraulic valve to drive a hydraulic motor such as an HPDU or brake element.

In block 528, one or more operating parameter measurements are acquired. In some embodiments, the operating parameters may be, for example, position or movement of a gearbox, ballscrew, gear drive, HPDU, pylon, or the like. The operating parameter measurements may be measurements or signals that are associated with the operating parameters. For example, a resolver may provide data, such as position or angle data which may be used to determine a position or movement of a gearbox, ballscrew, gear drive, HPDU, pylon, or the like. In another example, the resolver data may be used to indirectly determine a pressure being applied to a brake or HPDU, with the gearbox motion and valve positioning indirectly indicating the pressure.

In block 530, the operating parameters are compared to a threshold. The operating parameters may be used to determine whether the relevant PCA elements have failed or passed a particular test, and the test passage or failure may be based on a relationship between the operating parameters and the threshold. For example, where multiple HPDUs are driven against a brake to determine whether the brake holds sufficiently, the operating parameter may be the movement or position of the ballscrew, and movement greater than a maximum allowable movement threshold or position error threshold may indicate a latent failure, or actual failure of the brake. In block 532, an alert may be raised. In some embodiments, raiding of the alert may be performed in response to an element failing a test, or otherwise according to the relationship between the operating parameter and the threshold.

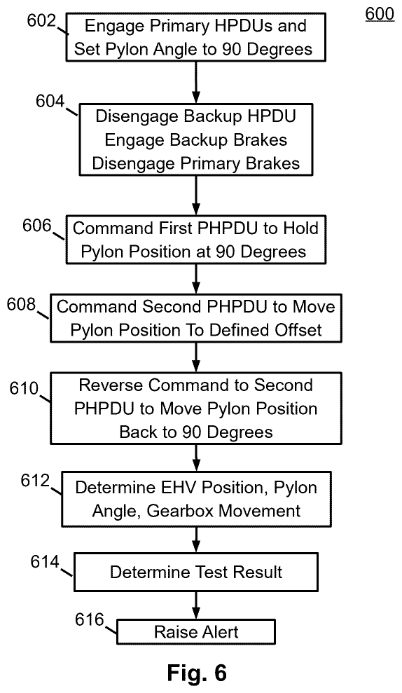

FIG. 6 is a flow diagram illustrating a method 600 for performing a primary HPDU torque comparison test according to some embodiments. The primary HPDU torque comparison test is a comparison of the output torques generated by the first PHPDU and second PHPDU when the two PHPDUs are driven into each other, with the two PHPDUs acting against each other. In block 602, the PHPDUs are both engaged, and are commanded to set the pylon angle to 90 degrees. With the pylon raised, the majority or the weight is directed downward along the pivot mechanism, rather than requiring the PCA to support the weight of the pylon, as when the pylon is set to 0 degrees for horizontal flight. In block 604, the BHPDU is disengaged, or in bypass mode, and allowed to turn freely. Additionally, the backup brakes are engaged to prevent the secondary gearbox from turning, and the primary brakes are dis engaged to permit the primary gearbox to turn. In block 606, the first PHPDU is commanded to hold the pylon position at 90 degrees, and in block 608, the second PHPDU is commanded to move the pylon position to a defied offset. This causes the PHPDUs to work against each other, with one PHPDU attempting to move the pylon while the other holds the pylon in place. In some embodiments, the commands to both of the PHPDUs may be reversed so that the PHPDUs are driven into each other in the opposite direction, and so that PHPDUs are compared to each other in both directions.

In block 610, the command to the second PHPDU is reversed, and the second PHPDU is commanded to move the pylon back to 90 degrees. This results in both PHPDUs setting the pylon to the same angle, and alleviates the contrary instructions between the PHPDUs. In block 612, the position of electrohydraulic servo valves (EHVs) controlling actuation of the PHPDUs is determined, as these positions control how much hydraulic fluid volume was needed to hold the pylon or attempt to move the pylon. Thus, an indirect pressure determination may be made, as in some embodiments, the PHPDUs omit pressure sensors. The pylon position and any gearbox movement may also be determined. The gearbox movement may be movement of a gear drive, transmission, or the like, or may be movement of the ballscrew. The movement of the pylon or gearbox is determined while the PHPDUs are acting against each other, with movement indicating that one PHPDU is weaker than the other. The gearbox movement may be determined according to operating parameter measurements made by one or more gearbox resolvers connected to, and driven by, the primary gearbox. The operating parameter measurements may be data in, or indicated by, signals generated by the resolvers, which may send the operating parameter data to a test controller, FCC, or the like. In block 614, a test result is determined. In some embodiments, the determined gearbox movement or pylon position or position change may be compared by an FCC, test controller to the like, to a threshold to identify a system with movement or position that exceeds the threshold resulting in the system failing the test. In some embodiments, the pressures required to stall the PHPDUs may be compared to each other, and a difference in pressure for stall between the different PHPDUs may be compared to a threshold to determine whether the system fails the test. In block 616, an alert may be raised if the system fails the test.

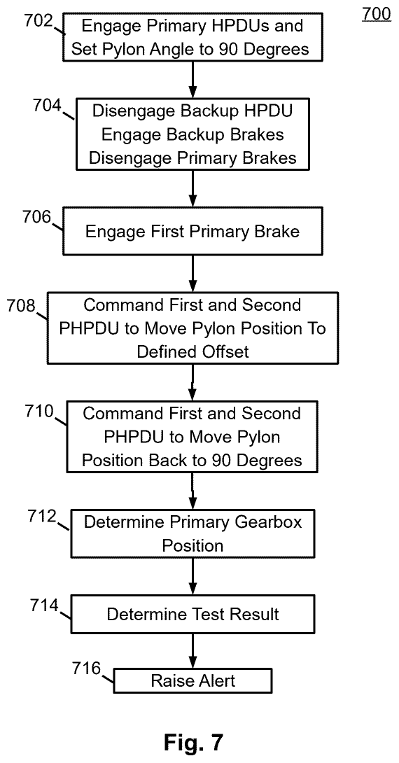

FIG. 7 is a flow diagram illustrating a method 700 for performing a primary brake system hold torque test according to some embodiments. The primary brake system test may include driving both PHPDUs into a single primary brake to ensure that the brake is capable of holding or restraining the gearbox against movement by two PHPDUs. Each primary brake may be tested in this manner to ensure that, should a primary brake fail the remaining primary brake is able to handle the total load that may be created by the PHPDUs. In block 702, the PHPDUs are engaged and commanded to set the pylon angle to about 90 degrees. In block 704, the BHPDU is disengaged, and the backup brakes are engaged to hold the secondary gearbox. The primary brakes are also disengaged. In block 706 a first primary brake is engaged with the first primary brake being the brake selected for testing. In block 708 the PHPDUs are commanded to move the pylon position to a predefined offset. Thus, both the first and second PHPDUs attempt to drive the gearbox together in a same direction to attempt to move the pylon while the brake under test holds the gearbox to prevent movement of the pylon. In block 710, the first and second PHPDUs are commanded to move the pylon position back to 90 degrees, relieving the pressure put on the brake under test by the PHPDUs. In block 712, the position or movement of the primary gearbox is determined while the PHPDUs attempt to move the pylon to the defined offset. The pylon position and any gearbox movement may also be determined. The gearbox movement may be movement of a gear drive, transmission, or the like, or may be movement of the ballscrew. The movement of the gearbox or a pylon is determined while the PHPDUs are acting against the brake, with movement indicating that the primary brake under test is too weak to resist movement by both PHPDUs. In a perfectly operating system, no motion or position change would be observed, however, gear lash, system slop, inertia, or the like, may result in some initial movement before the movement substantially stops. The gearbox movement may be determined according to operating parameter measurements made by one or more gearbox resolvers connected to, and driven by, the primary gearbox. The operating parameter measurements may be data in, or indicated by, signals generated by the resolvers, which may send the operating parameter data to a test controller, FCC, or the like.

In block 714, a test result is determined. In some embodiments, the determined primary gearbox movement, gearbox position or gearbox position change may be compared by an FCC, test controller to the like, to a threshold to identify a system with movement or position that exceeds the threshold, resulting in the system failing the test. In some embodiments, the pressures required to stall the PHPDUs may be compared to each other, and a difference in pressure for stall between the different PHPDUs may be compared to a threshold to determine whether the system fails the test.

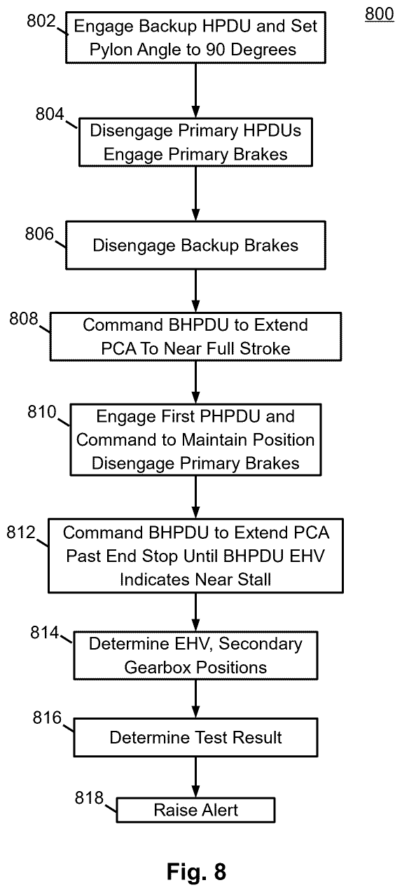

FIG. 8 is a flow diagram illustrating a method 800 for performing a backup HPDU torque comparison test according to some embodiments. In the BHPDU torque test, the BHPDU may be driven against a PHPDU to determine the torque output of the BHPU. This is contrast to the PHPDU torque comparison test since the PCA has a single PHPDU, without a second BHPDU to compare torque against.

In block 802, the BHPDU is engaged and commanded to move the pylon position to 90 degrees. In block 804, the PHPDUs are disengaged and the primary brakes are engaged. In block 806, the backup brakes are disengaged, and in block 808, the BHPDU is commanded to extend the PCA to near full stroke, with the ballscrew extended almost completely. In block 810, the first PHPDU is engaged and commanded to maintain the revolver position. Additionally, the primary braked are disengaged. In block 812, the BHPDU is commanded to extend the PCA past the end sip, until the BHPDU EHVs indicates that the BHPDU is near stall. In block 814, the position of one or more EHVs controlling actuation of the BHPDU and of the first PHPDU is determined, indicating an indirect pressure at which the BHPDU and first PHPDU were operating just prior to stall. A pylon position and any gearbox movement may also be determined. The gearbox movement may be movement of a gear drive, transmission, or the like, or may be movement of the ballscrew. The movement of the pylon or gearbox is determined while the first PHPDU and BHPDU are acting against each other, with movement indicating that the BHPDU is weaker or stronger than the first PHPDU. The gearbox movement may be determined according to operating parameter measurements made by one or more gearbox resolvers connected to, and driven by, the primary or secondary gearbox. The operating parameter measurements may be data in, or indicated by, signals generated by the resolvers, which may send the operating parameter data to a test controller, FCC, or the like.

In block 816, a test result is determined. In some embodiments, the determined gearbox movement or pylon position or position change may be compared by an FCC, test controller to the like, to a threshold to identify a system with movement or position that exceeds the threshold resulting in the system failing the test. In some embodiments, the pressures required to stall the BHPDU may be compared to the pressure exerted by the first PHPDU and a difference in pressure may be compared to a threshold to determine whether the system fails the test. In block 818, an alert may be raised if the system fails the test.

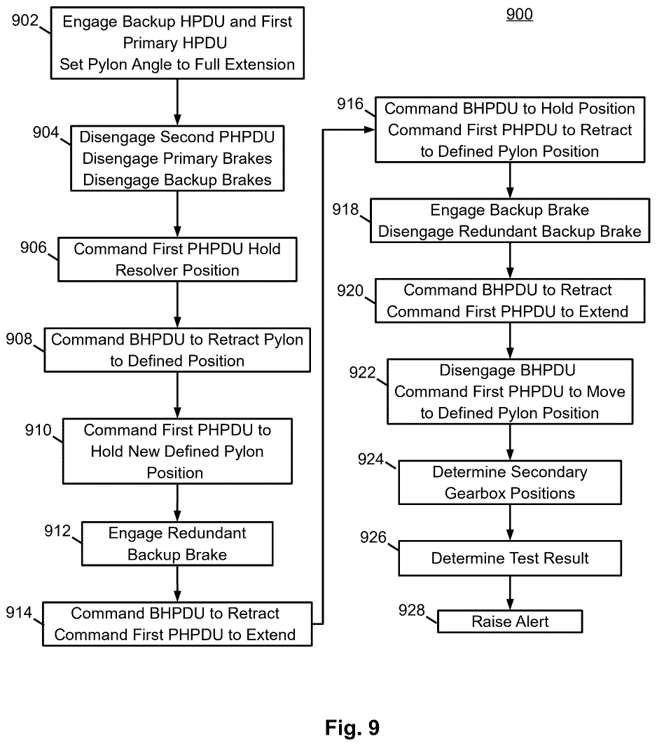

FIG. 9 is a flow diagram illustrating a method 900 for performing a backup brake system hold torque test according to some embodiments. The backup brake system test may include driving a PHPDU and the BHPDU into a single backup brake to ensure that the backup brake is capable of holding or restraining the gearbox against movement by two HPDUs. For example, were the primary brakes to fail, the backup brakes may be needed to brake the PHPDUs. A PHPDU is driven into the backup brake under test since the PCA has a single BHPDU.

In block 902, the BHPDU and a first PHPDU are engaged and commanded to set the pylon angle to full extension. In block 904, the second PHPDU is disengaged, and the backup and primary brakes are all disengaged. In block 906 a first primary brake is engaged with the first primary brake being the brake selected for testing. In block 908, the BHPDUs is commanded to move the pylon position to a predefined offset or position, and in block 910, the fist PHPDU is commanded to maintain that pylon position. Thus, both the first PHPDU and BHPDU hold the pylon selected position. In block 912, the redundant backup brake is engaged to hold the secondary gearbox in the selected position. In block 914, the BHPDU is commanded to retract the ballscrew, and the first PHPDU is commanded to extend the ballscrew. This results in both the first PHPDU and the BHPDU move the ballscrew in the same direction so that the redundant brake experiences the pressure applied by two HPDUs.

A similar test may be applied to the backup brake so that the backup brake and the redundant backup brake are tested separately.

In block 916, the BHPDU is commanded to hold position, while the first PHPDU is commanded to retract to a defined position. In block 918, the backup brake is engaged, and the redundant backup brake is disengaged. This switches the redundant backup brake being under test to the backup brake being under test. In block 920, the BHPDU is commanded to retract and the fist PHPDU is command to extend, casing both the BHPDU and first PHPDU to attempt to move the ballscrew in the same direction and applying pressure from two HPDUs to the backup brake. In block 922, the BHPDU is disengaged and the first PHPU is commanded to move to a defined pylon position.

In block 924, the position or movement of the second gearbox is determined while the first PHPDU and BHPDU attempt to move the pylon to the defined pylon position. The pylon position may also be determined. The gearbox movement may be movement of a gear drive, transmission, or the like, or may be movement of the ballscrew. The movement of the gearbox or a pylon is determined while the first PHPDU and BHPDU are acting against the brake, with movement indicating that the backup brake under test is too weak to resist movement by both HPDUs. In a perfectly operating system, no motion or position change would be observed, however, gear lash, system slop, inertia, or the like, may result in some initial movement before the movement substantially stops. The gearbox movement may be determined according to operating parameter measurements made by one or more gearbox resolvers connected to, and driven by, the secondary gearbox or primary gearbox. The operating parameter measurements may be data in, or indicated by, signals generated by the resolvers, which may send the operating parameter data to a test controller, FCC, or the like.

In block 926, a test result is determined. In some embodiments, the determined secondary gearbox movement, gearbox position or gearbox position change may be compared by an FCC, test controller to the like, to a threshold to identify a system with movement or position that exceeds the threshold, resulting in the system failing the test. In block 928, an alert may be raised if the system fails the test.

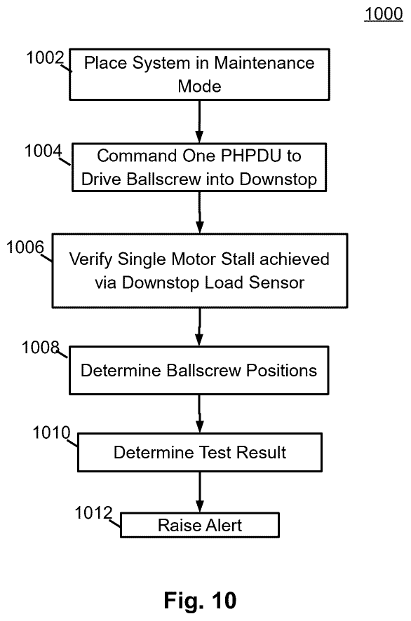

FIG. 10 is a flow diagram illustrating a method 1000 for performing an independent primary HPDU torque confirmation test according to some embodiments. In some embodiments, the independent PHPDU torque test may be a test where a PHPDU drives the ballscrew to a mechanical stop position, and the pressure detected by a sensor in the stop itself is used, along with the ballscrew position, to determine the torque provided by an individual PHPDU. This is in contrast to the comparative HPDU tests, which compares the relative torques. In the independent torque test, the HPDUs may be tested to determine whether the HPDUs have deteriorated in equal amounts, while the torque comparison test determine whether the torques for different HPDUs do not match. In block 1002, the system is placed in a maintenance mode. The maintenance mode may include rotating the rotor so that the pylon may be rotated to its lowest or highest position without the rotor blades striking the ground or otherwise being dangerous. This may not be possible in normal testing, as the rotor blades may be turned so that a pivoting the pylon causes a low-hanging rotor blade to strike the ground during pylon pivoting. In block 1004, a first PHPDU is commanded to drive the ballscrew into a downstop. This causes the ballscrew to bottom out in the fully retracted position with the ballscrew contacting an internal frame, bracket on the airframe, or the like. In block 1006, the testing system, such as the FCC, verifies that a single motor stall is achieved via a downstop load sensor. The downstop load sensor may be a pressure sensor that detects the ballscrew or another portion of the PVA contacting a fixed stop surface, and may provide a signal indicating a sensed force. In block 1008, a ballscrew position is determined. In some embodiments, a resolver determines the ballscrew position to ensure that the ballscrew has fully engaged the downstop, and to provide positional data that is used, with the data indicating the pressure applied to the downstop sensor, the toque applied by the first PHPDU.

In block 1010, a test result is determined. In some embodiments, the torque generated by the PHPDU is determined, according to the ballscrew position and downstop sensor force, and may be compared by an FCC, test controller to the like, to a threshold to identify a system with torque that falls below the threshold, resulting in the system failing the test. In block 1012, an alert may be raised if the system fails the test.

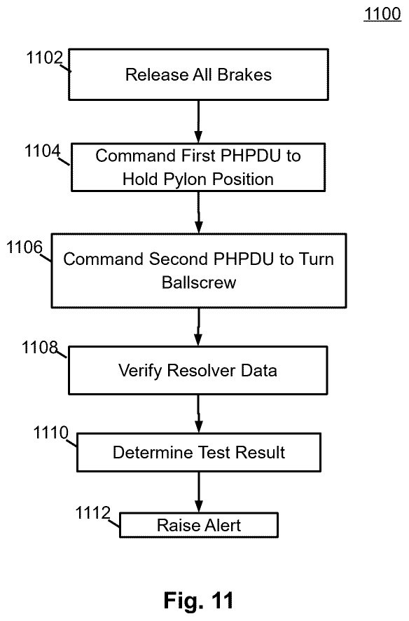

FIG. 11 is a flow diagram illustrating a method for performing a gearbox resolver verification test according to some embodiments. The gearbox resolver verification test may be used to verify that a resolver gives accurate angle or position information throughout a range of motion, such as a full rotation. The test may also verify that a gear drive, gear train, transmission, or the like is in acceptable shape, for example, with all gear teeth in working order and the gears meshing correct. In block 1102, all brakes may be released. In block 1104, a first PHPDU may be commanded to hold a particular pylon position, and in block 1106, a second PHPDU may be commanded to turn the ballscrew. Thus, the first ballscrew may be in a pylon position mode, adjusting the relative position of the cabal screw based on feedback from a resolver, and the second PHPDU may be in freely rotating mode without attempting to achieve a particular pylon position. This mixture of modes holds the pylon in a fixed position while the second PHPDU moves, as the first PHPDU continually compensates for the second PHPDU drive of the ballscrew.

In block 1108, the resolver data is verified. Data may be collected, by an FCC, testing controller, or the like, from a resolver undertest, with the resolver indicating resolver testing data regarding one or more position of the ballscrew, angles of the resolver, or the like. The resolver testing data may be compared to resolver baseline data from previous tests, from a different resolver, from a different gearbox, from an HPDU, or the like.

In block 1110, a test result is determined. In some embodiments, the data generated by a resolver is verified, and may be compared to an error threshold or the like threshold to identify a system with a resolver error that exceed the threshold, resulting in the system failing the test. In block 1112, an alert may be raised if the system fails the test.

An embodiment method comprises driving a pylon conversion actuator (PCA) that controls tilt of a pylon of a tilt-wing aircraft to a predetermined position, driving a selected element of the PCA to attempt to move a PCA element of the PCA, wherein driving the selected element of the PCA is part of a position based test for failure of a test element of the PCA, acquiring an operating parameter measurement by a resolver mechanically connected to the PCA element, wherein the operating parameter measurement is associated with an operating parameter of the PCA element, wherein the operating parameter is associated with movement while the selected element of the PCA is being driven or position of the PCA element as a result of the PCA being driven, determining, according to a relationship between the operating parameter and a threshold, whether the test element fails the position based test, and raising an alert through an alert system in response to the test element failing the test.

In some embodiments, the method further comprises enabling a selected holding element, wherein the selected holding element attempts to restrain drive of the selected element. In some embodiments, the position based test for failure is a primary hydraulic power drive unit (HPDU) torque comparison test, wherein the test element is a first primary HPDU of the PCA, wherein the selected holding element is a second primary HPDU of the PCA, and wherein driving the selected element comprises driving the first primary HPDU against drive of the second primary HPDU. In some embodiments, the position based test for failure is a primary brake system hold torque test, wherein the test element is a first primary brake of the PCA, wherein the selected element comprises two or more primary hydraulic power drive units (HPDUs) of the PCA, and wherein driving the selected element comprises driving the two or more primary HPDUs against a restraint of the first primary brake. In some embodiments, the position based test for failure is a backup hydraulic power drive unit (HPDU) torque comparison test, wherein the test element is a backup HPDU of the PCA, wherein the selected element comprises a first primary HPDU of the PCA, and wherein driving the selected element comprises driving the backup HPDU against drive of the first primary HPDU. In some embodiments, the position based test for failure is a backup brake system hold torque test, wherein the test element is a backup brake of the PCA, wherein the selected element comprises a first primary hydraulic power drive unit (HPDU) of the PCA and a backup HPDU of the PCA, and wherein driving the selected element comprises driving the first primary HPDU and the backup HPDU against a restraint of the backup brake. In some embodiments, the position based test for failure is a gearbox resolver verification test, wherein the test element is resolver mechanically connected to element of the PCA, wherein the selected element comprises a first primary hydraulic power drive unit (HPDU) of the PCA, and wherein driving the selected element comprises driving the first primary HPDU to turn the resolver through a complete revolution of the resolver by moving a ballscrew of the PCA. In some embodiments, the position based test for failure is an independent primary hydraulic power drive unit (HPDU) torque confirmation test, wherein the test element is a first primary HPDU of the PCA, and wherein driving the selected element comprises driving the first primary HPDU to move a ballscrew of the PCA against a downstop.

An embodiment system includes one or more processors, and at least one non-transitory computer readable memory connected to the one or more processors and including computer program code implementing a position based test for failure of a test element of pylon conversion actuator (PCA) that controls tilt of a pylon of a tilt-wing aircraft. The at least one non-transitory computer readable memory and the computer program code are configured, with the one or more processors, to cause the system to perform at least driving a selected element of the PCA to attempt to move a PCA element, acquiring operating parameter measurement by a resolver mechanically connected to the PCA element, wherein the operating parameter measurement is associated with an operating parameter of the PCA element, wherein the operating parameter is associated with movement while the selected element of the PCA is being driven or position of the PCA element as a result of the PCA being driven, determining, according to a relationship between the operating parameter and a threshold, whether the test element fails the position based test, and raising an alert through an alert system in response to the test element failing the test.

In some embodiments, the at least one non-transitory computer readable memory and the computer program code are further configured, with the one or more processors, to cause the system to perform enabling a selected holding element, wherein the selected holding element attempts to restrain drive of the selected element. In some embodiments, the position based test for failure is a primary hydraulic power drive unit (HPDU) torque comparison test, wherein the test element is a first primary HPDU of the PCA, wherein the selected holding element is a second primary HPDU of the PCA, and wherein driving the selected element comprises driving the first primary HPDU against drive of the second primary HPDU. In some embodiments, the position based test for failure is a primary brake system hold torque test, wherein the test element is a first primary brake of the PCA, wherein the selected element comprises two or more primary hydraulic power drive units (HPDUs) of the PCA, and wherein driving the selected element comprises driving the two or more primary HPDUs against a restraint of the first primary brake. In some embodiments, wherein the position based test for failure is a backup hydraulic power drive unit (HPDU) torque comparison test, wherein the test element is a backup HPDU of the PCA, wherein the selected element comprises a first primary HPDU of the PCA, and wherein driving the selected element comprises driving the backup HPDU against drive of the first primary HPDU. In some embodiments, the position based test for failure is a backup brake system hold torque test, wherein the test element is a backup brake of the PCA, wherein the selected element comprises a first primary hydraulic power drive unit (HPDU) of the PCA and a backup HPDU of the PCA, and wherein driving the selected element comprises driving the first primary HPDU and the backup HPDU against a restraint of the backup brake. In some embodiments, the position based test for failure is a gearbox resolver verification test, wherein the test element is resolver mechanically connected to element of the PCA, wherein the selected element comprises a first primary hydraulic power drive unit (HPDU) of the PCA, and wherein driving the selected element comprises driving the first primary HPDU to turn the resolver through a complete revolution of the resolver by moving a ballscrew of the PCA. In some embodiments, the position based test for failure is an independent primary hydraulic power drive unit (HPDU) torque confirmation test, wherein the test element is a first primary HPDU of the PCA, and wherein driving the selected element comprises driving the first primary HPDU to move a ballscrew of the PCA against a downstop.

An embodiment method includes driving a selected element of a pylon conversion actuator (PCA) of a tilt-wing aircraft to attempt to move a PCA element of the PCA, wherein driving the selected element of the PCA is part of a position based test for failure of a test element of the PCA, enabling a selected holding element, wherein the selected holding element attempts to restrain drive of the selected element, acquiring an operating parameter measurement wherein the operating parameter measurement is associated with an operating parameter of the PCA element, wherein the operating parameter is associated with movement of a ballscrew of the PCA while the selected element of the PCA is being driven or position of the PCA element as a result of the PCA being driven, determining, according to the operating parameter, whether the test element fails the position based test, and raising an alert through an alert system in response to the test element failing the test.

In some embodiments, the PCA comprises a ballscrew, a primary gearbox and a secondary gearbox, one or more brakes, and one or more hydraulic power drive units (HPDUs), wherein the one or more HPDUs comprises two or more primary HPDUs disposed in the primary gearbox and connected to a first portion of the ballscrew, wherein the one or more HPDUs comprises at least one backup HPDUs disposed in the secondary gearbox and connected to a second portion of the ballscrew, and wherein the one or more brakes comprises two or more primary brakes, wherein each of the primary brakes is associated with a primary HPDU of the one or more primary HPDUs and is disposed in the primary gearbox and connected to the first portion of the ballscrew, wherein the one or more brakes further comprises a backup brakes associated with the at least one backup HPDU and is disposed in the second gearbox and connected to the second portion of the ballscrew, and wherein the one or more brakes further comprises a redundant backup brake separate from the at least one backup HPDU and disposed in the second gearbox and connected to the second portion of the ballscrew, wherein the test element comprises at least one of the one or more HPDUs or at least one of the one or more brakes. In some embodiments, driving the selected element comprises driving a first HPDU of the one or more HPDUs against a drive of a second HDPU of the one or more HDPUs to perform a HPDU torque comparison. In some embodiments, driving the selected element comprises driving two or more of the one or more HPDUs against a restraint of a first brake of the one or more brakes to test a brake system hold torque.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
driving a pylon conversion actuator (PCA) that controls tilt of a pylon of a tilt-wing aircraft to a predetermined position;
driving a selected element of the PCA to attempt to move a PCA element of the PCA, wherein driving the selected element of the PCA is part of a position based test for failure of a test element of the PCA;
acquiring an operating parameter measurement by a resolver mechanically connected to the PCA element, wherein the operating parameter measurement is associated with an operating parameter of the PCA element, wherein the operating parameter is associated with movement while the selected element of the PCA is being driven or position of the PCA element as a result of the PCA being driven;
determining, according to a relationship between the operating parameter and a threshold, whether the test element fails the position based test; and
raising an alert through an alert system in response to the test element failing the test.

2. The method of claim 1, further comprising enabling a selected holding element, wherein the selected holding element attempts to restrain drive of the selected element.

3. The method of claim 2, wherein the position based test for failure is a primary hydraulic power drive unit (HPDU) torque comparison test, wherein the test element is a first primary HPDU of the PCA, wherein the selected holding element is a second primary HPDU of the PCA, and wherein driving the selected element comprises driving the first primary HPDU against drive of the second primary HPDU.

4. The method of claim 2, wherein the position based test for failure is a primary brake system hold torque test, wherein the test element is a first primary brake of the PCA, wherein the selected element comprises two or more primary hydraulic power drive units (HPDUs) of the PCA, and wherein driving the selected element comprises driving the two or more primary HPDUs against a restraint of the first primary brake.

5. The method of claim 2, wherein the position based test for failure is a backup hydraulic power drive unit (HPDU) torque comparison test, wherein the test element is a backup HPDU of the PCA, wherein the selected element comprises a first primary HPDU of the PCA, and wherein driving the selected element comprises driving the backup HPDU against drive of the first primary HPDU.

6. The method of claim 2, wherein the position based test for failure is a backup brake system hold torque test, wherein the test element is a backup brake of the PCA, wherein the selected element comprises a first primary hydraulic power drive unit (HPDU) of the PCA and a backup HPDU of the PCA, and wherein driving the selected element comprises driving the first primary HPDU and the backup HPDU against a restraint of the backup brake.

7. The method of claim 2, wherein the position based test for failure is a gearbox resolver verification test, wherein the test element is resolver mechanically connected to element of the PCA, wherein the selected element comprises a first primary hydraulic power drive unit (HPDU) of the PCA, and wherein driving the selected element comprises driving the first primary HPDU to turn the resolver through a complete revolution of the resolver by moving a ballscrew of the PCA.

8. The method of claim 1, wherein the position based test for failure is an independent primary hydraulic power drive unit (HPDU) torque confirmation test, wherein the test element is a first primary HPDU of the PCA, and wherein driving the selected element comprises driving the first primary HPDU to move a ballscrew of the PCA against a downstop.

9. A system, comprising:
one or more processors; and
at least one non-transitory computer readable memory connected to the one or more processors and including computer program code implementing a position based test for failure of a test element of pylon conversion actuator (PCA) that controls tilt of a pylon of a tilt-wing aircraft, wherein the at least one non-transitory computer readable memory and the computer program code are configured, with the one or more processors, to cause the system to perform at least:
driving a selected element of the PCA to attempt to move a PCA element;
acquiring operating parameter measurement by a resolver mechanically connected to the PCA element, wherein the operating parameter measurement is associated with an operating parameter of the PCA element, wherein the operating parameter is associated with movement while the selected element of the PCA is being driven or position of the PCA element as a result of the PCA being driven;
determining, according to a relationship between the operating parameter and a threshold, whether the test element fails the position based test; and
raising an alert through an alert system in response to the test element failing the test.

10. The system of claim 9, the at least one non-transitory computer readable memory and the computer program code are further configured, with the one or more processors, to cause the system to perform enabling a selected holding element, wherein the selected holding element attempts to restrain drive of the selected element.

11. The system of claim 10, wherein the position based test for failure is a primary hydraulic power drive unit (HPDU) torque comparison test, wherein the test element is a first primary HPDU of the PCA, wherein the selected holding element is a second primary HPDU of the PCA, and wherein driving the selected element comprises driving the first primary HPDU against drive of the second primary HPDU.

12. The system of claim 10, wherein the position based test for failure is a primary brake system hold torque test, wherein the test element is a first primary brake of the PCA, wherein the selected element comprises two or more primary hydraulic power drive units (HPDUs) of the PCA, and wherein driving the selected element comprises driving the two or more primary HPDUs against a restraint of the first primary brake.

13. The system of claim 10, wherein the position based test for failure is a backup hydraulic power drive unit (HPDU) torque comparison test, wherein the test element is a backup HPDU of the PCA, wherein the selected element comprises a first primary HPDU of the PCA, and wherein driving the selected element comprises driving the backup HPDU against drive of the first primary HPDU.

14. The system of claim 10, wherein the position based test for failure is a backup brake system hold torque test, wherein the test element is a backup brake of the PCA, wherein the selected element comprises a first primary hydraulic power drive unit (HPDU) of the PCA and a backup HPDU of the PCA, and wherein driving the selected element comprises driving the first primary HPDU and the backup HPDU against a restraint of the backup brake.

15. The system of claim 10, wherein the position based test for failure is a gearbox resolver verification test, wherein the test element is resolver mechanically connected to element of the PCA, wherein the selected element comprises a first primary hydraulic power drive unit (HPDU) of the PCA, and wherein driving the selected element comprises driving the first primary HPDU to turn the resolver through a complete revolution of the resolver by moving a ballscrew of the PCA.

16. The system of claim 9, wherein the position based test for failure is an independent primary hydraulic power drive unit (HPDU) torque confirmation test, wherein the test element is a first primary HPDU of the PCA, and wherein driving the selected element comprises driving the first primary HPDU to move a ballscrew of the PCA against a downstop.

17. A method, comprising:
driving a selected element of a pylon conversion actuator (PCA) of a tilt-wing aircraft to attempt to move a PCA element of the PCA, wherein driving the selected element of the PCA is part of a position based test for failure of a test element of the PCA;
enabling a selected holding element, wherein the selected holding element attempts to restrain drive of the selected element;
acquiring an operating parameter measurement wherein the operating parameter measurement is associated with an operating parameter of the PCA element, wherein the operating parameter is associated with movement of a ballscrew of the PCA while the selected element of the PCA is being driven or position of the PCA element as a result of the PCA being driven;
determining, according to the operating parameter, whether the test element fails the position based test; and
raising an alert through an alert system in response to the test element failing the test.

18. The method of claim 17, wherein the PCA comprises a ballscrew, a primary gearbox and a secondary gearbox, one or more brakes, and one or more hydraulic power drive units (HPDUs), wherein the one or more HPDUs comprises two or more primary HPDUs disposed in the primary gearbox and connected to a first portion of the ballscrew, wherein the one or more HPDUs comprises at least one backup HPDUs disposed in the secondary gearbox and connected to a second portion of the ballscrew;
wherein the one or more brakes comprises two or more primary brakes, wherein each of the primary brakes is associated with a primary HPDU of the one or more primary HPDUs and is disposed in the primary gearbox and connected to the first portion of the ballscrew, wherein the one or more brakes further comprises a backup brakes associated with the at least one backup HPDU and is disposed in the second gearbox and connected to the second portion of the ballscrew, and wherein the one or more brakes further comprises a redundant backup brake separate from the at least one backup HPDU and disposed in the second gearbox and connected to the second portion of the ballscrew; and
wherein the test element comprises at least one of the one or more HPDUs or at least one of the one or more brakes.

19. The method of claim 18, wherein driving the selected element comprises driving a first HPDU of the one or more HPDUs against a drive of a second HDPU of the one or more HDPUs to perform a HPDU torque comparison.

20. The method of claim 18, wherein, driving the selected element comprises driving two or more of the one or more HPDUs against a restraint of a first brake of the one or more brakes to test a brake system hold torque.
